(19) United States
(12) Patent Application Publication
(10) Pub. No.: US 2012/0327034 A1
(43) Pub. Date: Dec. 27, 2012

(54) Touch-sensitive system with optical transmitters and receivers

(76) Inventors: Johanna Dominici, Eysines (FR); Arnaud Petitdemange, Blanquefort (FR); Loïc Becouarn, Pessac (FR)

(21) Appl. No.: 13/487,115

(22) Filed: Jun. 1, 2012

(30) Foreign Application Priority Data
Jun. 1, 2011 (FR) 1101680

(51) Int. Cl. G06F 3/042

(52) U.S. Cl. 345/175

(57) ABSTRACT

The general field of the invention is that of optical touch-sensitive systems mounted above areas of display surfaces. The system comprises at least two light sources arranged to produce above a display surface a “luminous layer” covering said surface, a first imager and a second imager the optical fields of which cover the surface. The sources are separate from the imagers. When a first object is situated above the surface, first and second luminous images of said object are captured by the first imager and the second imager, the system including analysis means enabling by triangulation of the known positions of the first and second luminous images, determination of the position of this first object above the display surface. In more elaborate configurations, the system comprises a plurality of sources of illumination and imagers enabling coverage of complex surfaces, enabling “multi-touch” detection or securing the detection functions.

The field of the invention is that of touch-sensitive systems, and more particularly touch-sensitive optical systems. The use of the system is not limited to a particular application but the system applies very particularly to aircraft instrument panels and their avionic systems.

In the earliest days of commercial aviation, five aircrew were necessary to effect a flight. This number was then reduced to three. In the 1980s, with the general adoption of “glass cockpits”, i.e. cockpits with large display screens dedicated to piloting and navigation, the flight engineer station was eliminated and the number of aircrew thus changed to two.

Today, interaction between the aircrew and cockpit screens is mainly effected via keyboards and “mouse” type computer interfaces or “trackballs”. However, the increasing workload on aircrew caused by the increase in air traffic and the tendency to reduce the number of aircrew are leading aircraft manufacturers and aeronautical systems suppliers to seek ever more efficient and ever more ergonomic man-machine interfaces. Designers are working in particular on the capability of the devices to be “multi-touch” devices, i.e. devices able to respond simultaneously to a plurality of actions effected by the pilot or aircrew.

The use of touch-sensitive screens as man-machine interaction means is becoming more and more widespread in everyday life. This interaction means greatly facilitates the use of the associated device, through being more intuitive and faster. The use of touch-sensitive screens thus facilitates interaction between the aircrew and the cockpit screens, thus increasing flight safety at the same time as reducing the workload on the aircrew.

However, the introduction of touch-sensitive screens into a cockpit gives rise to certain problems. A cockpit screen must respond to certain environmental requirements. These include optical constraints, vibration, electromagnetic interference, resistance to heat, shocks, liquids, etc. Adding the touch-sensitive technology to the screen makes it more difficult to comply with these requirements.

Today, few aircraft are equipped with touch-sensitive screens and for those which are the touch-sensitive screens are not critical screens such as the primary flight display (PFD) or navigation display (ND) screens that provide fundamental information concerning piloting and navigation.

There currently exist various so-called “multi-touch” touch-sensitive system technologies. They include resistive, projected capacitive. optical, acoustic and “in-cell” systems. Optical technologies include so-called “optical imaging”, “infrared matrix” and “frustrated total internal reflection” (FTIR) technologies. These technologies are nevertheless not perfectly adapted to use in an avionic environment for the critical screens in a cockpit.

The “multi-touch” capability is provided by the following technologies, which have the following limitations:

Resistive technology
addition of a glass pad in front of the screen;
degraded screen reflectivity;
reduced screen brightness;
necessity for a high activation force for “glass-glass” solutions hardened for the avionics environment;
possible generation of false activations or “ghosts” in “dual-touch” use;
wide screen borders for the wired connections to the screen.
   Projected capacitive technology
resolution limited by the size of the activation elements;
high sensitivity to electromagnetic radiation and moreover a technology that produces radiation;
serious difficulties for activation wearing gloves;
impossibility of activation with an object such a pen.
   Acoustic technology
immature technology;
sensitivity to the vibrating environment;
degraded optical performance of the screen, the surface of the screen being “suspended” to isolate it from the rest of the product.
   “In-cell” technologies integrated into the LCD panel
optical technology: presence of light indispensible: problems with night use;
capacitive technology: indispensible deformation of the screen surface: incompatible with the reinforcing glass added in avionics to protect and retain the screens.
   “Infrared matrix” technology
limited resolution: mediocre and crenellated line tracing;
use of a large number of components (illumination LEDs and photosensors) which compromises reliability and product service life:
incompatibility problems when using night vision goggles.
   “FTIR” technology
degraded optical performance caused by adding a glass pad in front of the screen;
degraded screen reflectivity;
reduced screen brightness;
incompatibility problems when using night vision goggles.
   “Optical imaging” technology
limited use under strong lighting when the sensors are saturated;
presence of phantom images in “dual-touch” use;
incompatibility problems when using night vision goggles.

Of the optical technologies. “optical imaging” systems are the most widespread at present. Various technological principles exist implementing this technology. One example is the “optical position detector” of the Japanese company EIT Co that is the subject matter of PCT patent application WO 2005/031554.

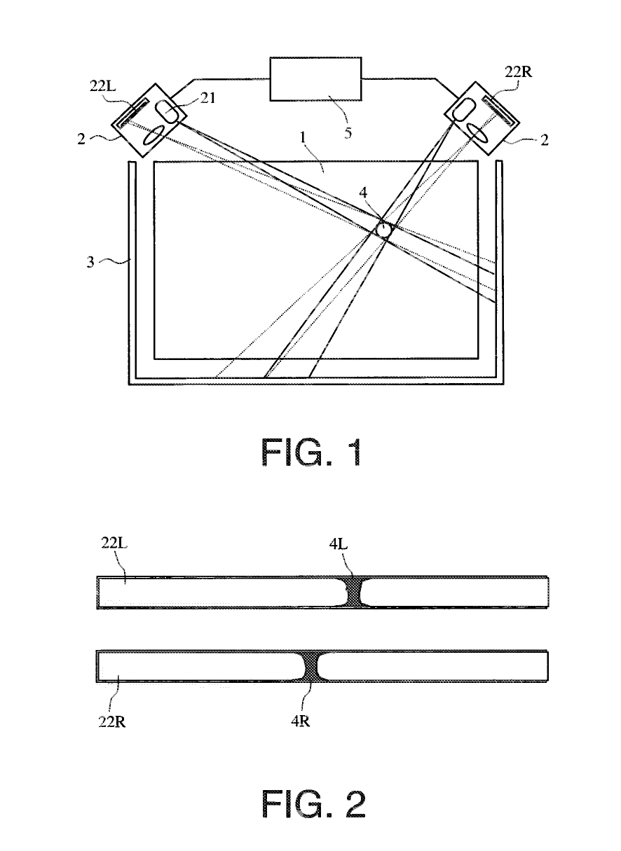

The technical principle described in the above application is represented in FIGS. 1 and 2 which are based on the figures of the application. As seen in FIG. 1, the device used to detect the position of an object or a finger of a user on a surface 1 essentially comprises two identical transmit-receive modules 2 and a retro-reflecting barrier 3 disposed at the periphery of the surface 1. This barrier is U-shaped in FIG. 1. Each transmit-receive module 2 comprises a light source 21 arranged to illuminate the whole of the surface 1 and a receiving system comprising a linear or surface photosensitive sensor 22 the field of which covers the whole of the surface 1. Operation is as follows. In the absence of any object in the vicinity of or in contact with the surface, the light emitted by a light source 21 is retro-reflected by the barrier 3 and illuminates the entirety of the surface of the sensor 22. In the presence of an object 4 in the vicinity of or in contact with the surface, the light emitted by the light source 21 and intercepted by the object, either before or after reflection at the barrier, does not reach the surface of the sensor 22 and creates a shadow. FIG. 2 shows the distribution of light over the sensors 22R and 22L of the modules 2 situated on the left and on the right of the surface 1. The positions of the shadows 4R and 4L are representative of the position of the object on the surface 1. By analyzing their exact positions on the sensors 22R and 22L, it is easy to determine the position of the object 4. The computer 5 carries out this processing.

Other variants of this system exist. For example, the border of the screen may be illuminated either by external infrared illuminators or by infrared illuminators integrated into the border. Two matrix sensors then image the light border and detect the presence of a shadow when a pointer interacts with the screen.

These technical solutions have the following limitations and drawbacks:
NVG (Night Vision Goggle) compatibility: the light sources operate at a wavelength in the near infrared, for example 880 nm, which makes them incompatible with the use of night vision goggles;
Low brightness dynamic: current solutions, based on CCD or CMOS type matrix sensors, have limited acquisition dynamics; these sensors cannot, at fixed exposure time, function over a very wide range of brightness, but sunlight entering a cockpit can vary by several orders of magnitude; an optical imaging touch-sensitive screen is quickly saturated by ambient light with the screen in direct sunlight;
Image processing complexity: the existing so-called “COTS” solutions use electronic components and software deemed complex by avionics certification authorities; a matrix sensor necessitates sophisticated control and acquisition electronics; access to the sources of the software used is difficult; the component may also be costly;
possibility of false activation linked to phantom images: in so-called “dual-touch” operation using two pointers simultaneously, current solutions often feature detection artifacts generating false activations.

Whilst preserving the advantages of the “optical imaging” technology, the system of the invention solves several of the above problems in whole or in part. The solution consists in a set of optical sensors and sources of illumination positioned correctly to enable the detection of a pointer and its position on a screen where the display is dynamic or on a static display area. Unlike previous systems that rely on shadows, where the object to be detected appears dark on a bright background, the system of the invention operates by direct detection, the object to be detected being bright on a dark background at the level of the photosensitive surfaces.

This device preserves the advantages of so-called “optical imaging” systems, which are the non-degraded optical performance of the associated screen, the small overall size of the technology, the low cost because low-cost COTS components are used, the low mass of the system, the adaptability to different cockpit configurations, the possibility of having a very large touch-sensitive surface, etc.

Moreover, the solution of the invention solves the problems of NVG compatibility, “multi-touch” use, operation under high illumination, simple and controllable control electronics and associated software, the redundancy necessary to meet safety constraints.

Its other advantages are the use of a smaller number of light sources and great freedom in positioning them.

To be more precise, the invention consists in an optical touch-sensitive system mounted above a detection area of a display surface, said system comprising a first light source arranged to produce above said area of the display surface a “luminous layer” covering at least said area, a first imager and a second imager the optical fields of which cover at least said area, characterized in that, the first source being separate from the first and second imagers, when a first object is situated above said area, first and second luminous images of said object are captured by the first imager and the second imager, the system including analysis means enabling by triangulation of the known positions of the first and second luminous images, determination of the position of this first object above said area of the display surface.

The system advantageously includes a third imager so that, when first and second objects are situated above the area of the display surface, first, second and third luminous images of the first object are captured by the first, second and third imagers, fourth, fifth and sixth luminous images of the second object are captured by the first, second and third imagers, the system including analysis means enabling by triangulation of the known positions of the six luminous images, determination with certainty of the position of the first object and the second object above said area of the display surface.

The system advantageously includes a second light source separate from the first light source. In this case, in a first embodiment, the first and second light sources emit light periodically and never simultaneously during normal operation of the optical touch-sensitive system. In a second embodiment the first light source emits in a first spectral band, the second light source emits in a second spectral band separate from the first spectral band, the imagers comprising spectral filters enabling transmission of only one of the two spectral bands. The light sources may also be lit alternatively so as not to interfere with each other.

Advantageously, for night use with light-amplifying goggles, the source or sources emit or emits in a spectral band situated outside the amplification spectral band of night vision goggles and the imagers are sensitive in said spectral band of said light sources.

The light source or sources advantageously include or includes optical means arranged such that the mean illumination above the area of the display surface and in a plane perpendicular thereto is substantially constant. To be more precise the optical means comprise collimation optics and a light guide or a light guide including regularly disposed diffusing patterns.

The imager advantageously includes a sunshade and the periphery of the display surface is advantageously surrounded by a sunlight-absorbing barrier.

In a first application the display surface is of substantially rectangular shape and the touch-sensitive area covers the whole of said display surface.

In a second application the display surface includes a plurality of areas, the system including a plurality of light sources and imagers arranged so that the position of at least one object may be determined in each area.

The display surface is advantageously a display screen or includes static display areas.

In a preferred use the display surface belongs to an avionic system mounted in an aircraft cockpit. In this context the display surface covers a portion of or the whole of the instrument panel.

The invention will be better understood and other advantages will become apparent in the light of the following description, which is given by way of nonlimiting example, and the appended figures, in which:

FIGS. 1 and 2, already commented on, represent a prior art optical touch-sensitive system;

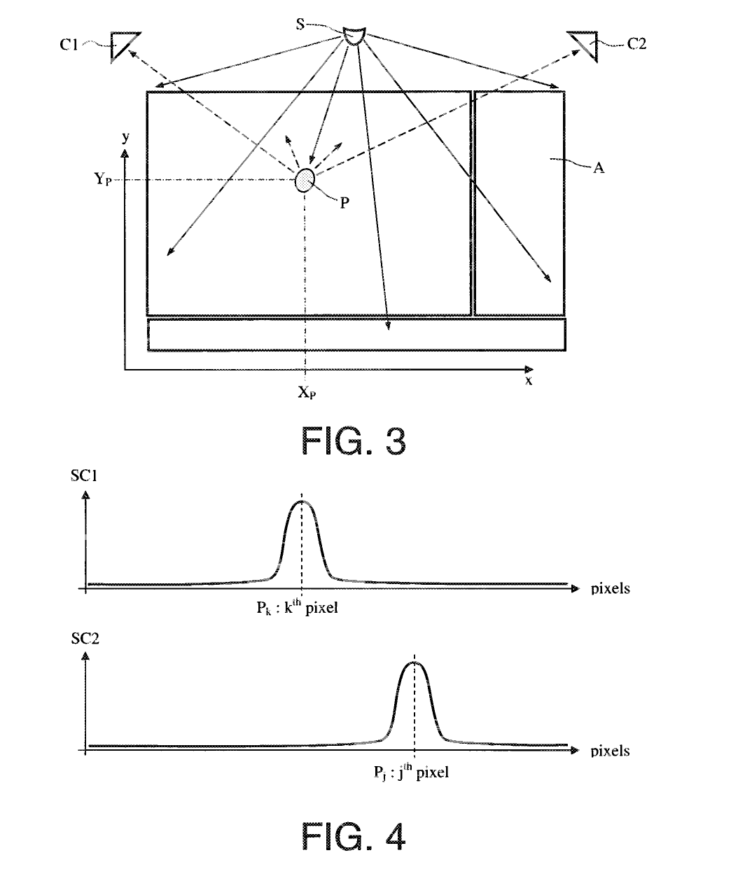

FIG. 3 represents a first optical touch-sensitive system of the invention comprising a light source and two imagers;

FIG. 4 represents the signals received by the imagers of FIG. 3 when the display area is pressed;

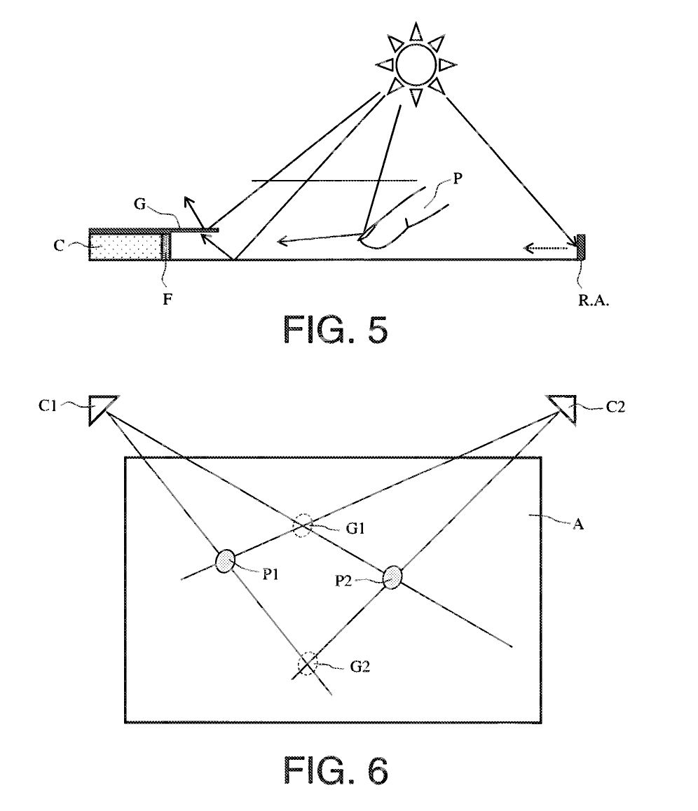

FIG. 5 represents the effects of illumination by sunlight and the means of attenuating them;

FIG. 6 illustrates the problem of determining simultaneously two positions when using two imagers;

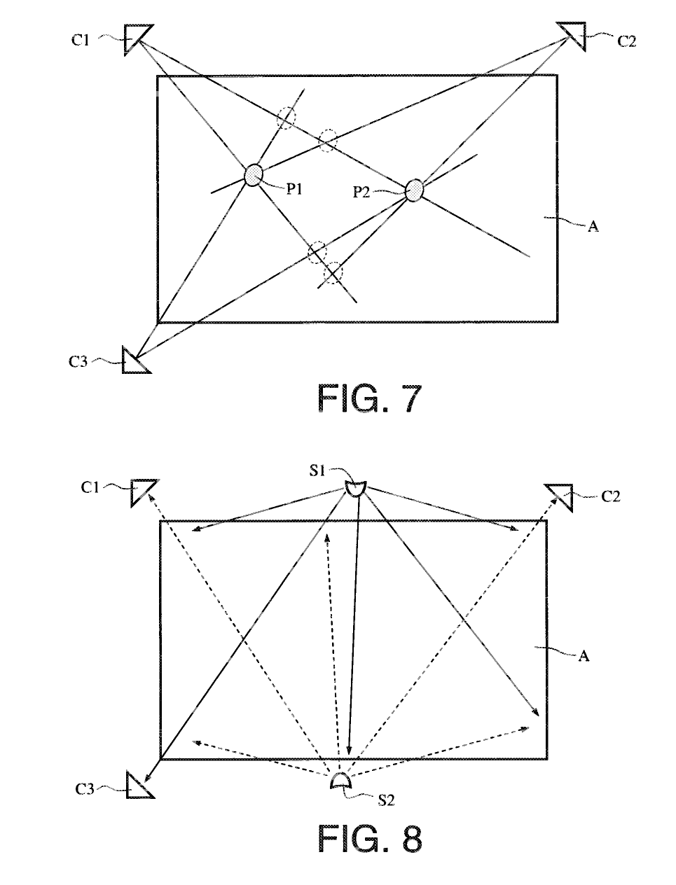

FIG. 7 illustrates determining simultaneously two positions when using three imagers;

FIG. 8 represents an optical touch-sensitive system of the invention comprising two light sources and three imagers;

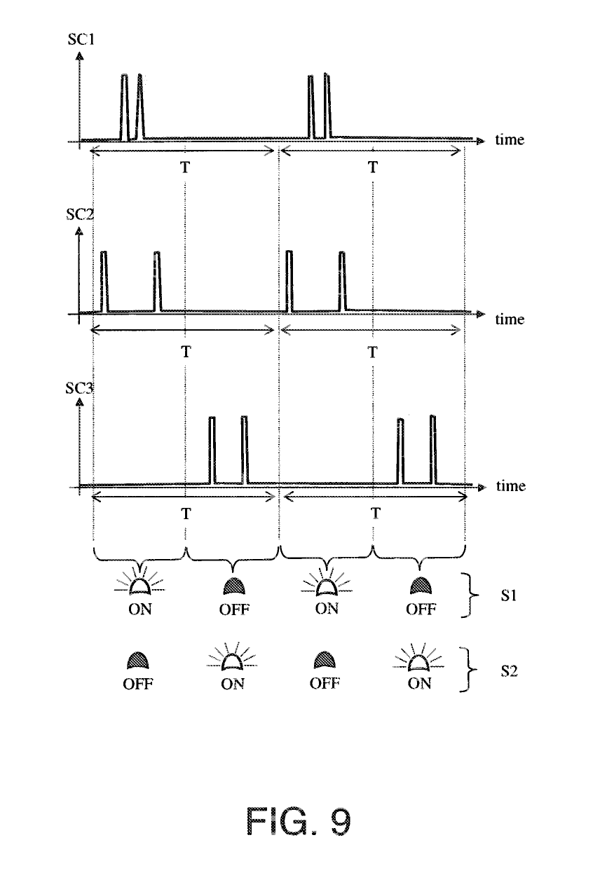

FIG. 9 represents one possible way of managing the light sources and the imagers of the previous device;

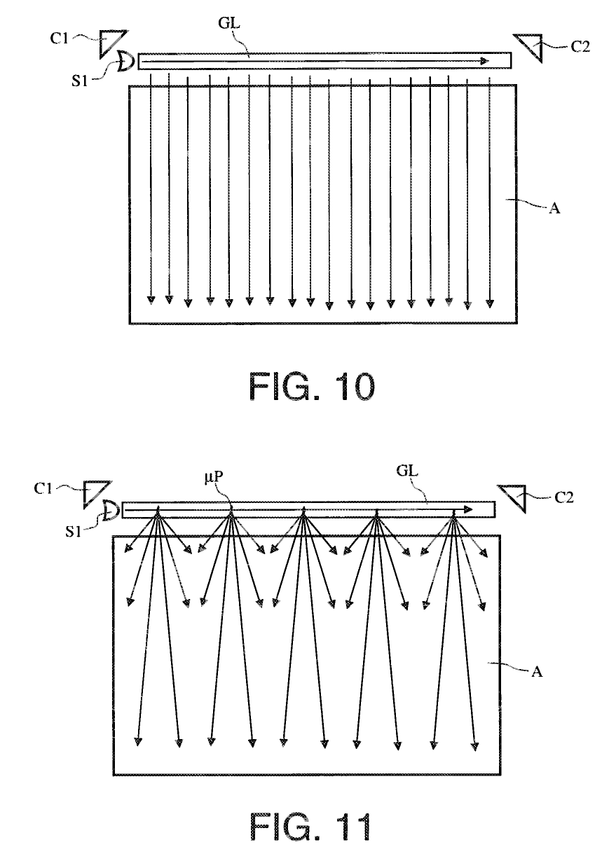

FIGS. 10 and 11 represent a solution in which the surface is illuminated by a beam covering the whole of the width of the screen;

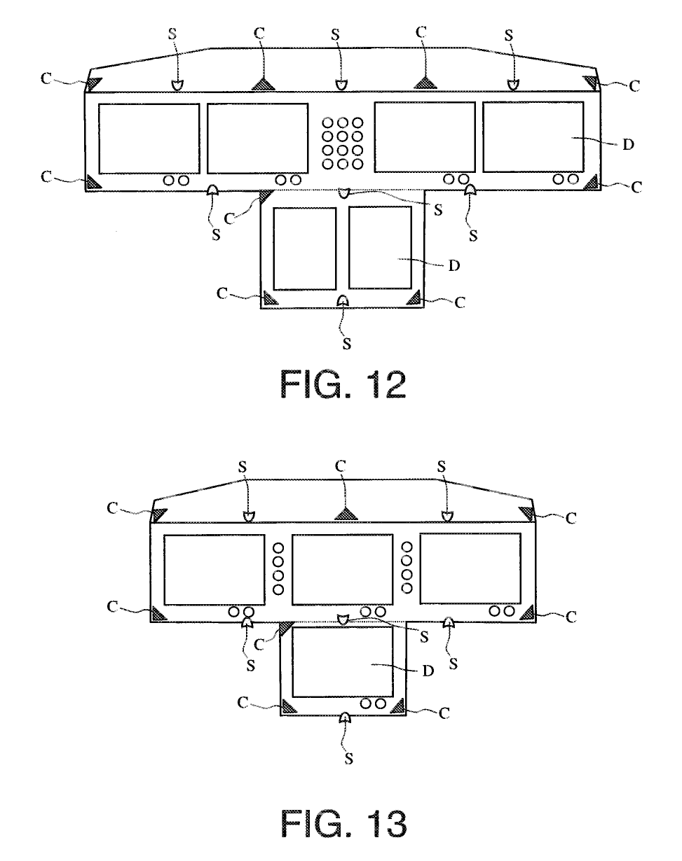

FIGS. 12 and 13 represent two aircraft instrument panels provided with optical touch-sensitive systems of the invention.

The optical touch-sensitive system of the invention is mounted above a detection area of a display surface. It generally comprises a set of optical imagers C and sources S of illumination correctly positioned to enable the detection of one or more pointers P and their position above the display surface A.

The display surface A may be one or more display screens. The expression dynamic display is then used. It may be a static display area produced by means of stickers or screen printing or a combination of these two functions.

The pointer P may be one or more fingers of the user, a stylus or any other object. The only conditions are that the pointer is not too wide to be detected accurately and that it is at least in part diffusing.

The general operating principle of systems of the invention is shown in FIGS. 3 and 4 in the simplest case, i.e. a single detection area A, a single source S of illumination, only two imagers C1 and C2 and only one pointer P to be detected. As will become clear, the principles described are easy to generalize to a plurality of detection areas and to a plurality of pointers to be detected. Similarly, the detection area in FIG. 3 is rectangular but the system of the invention may easily be adapted to different types of detection area shapes. The location of the source and the imagers is also specified by way of example.

The source S of illumination emits light parallel to the display area in a layer a few millimeters thick extending from the display surface. This “luminous layer” must of course cover all of the detection area and not illuminate the imagers. This light source is for illuminating the pointer P when it designates a particular location in the display area. Light-emitting diodes or laser diodes may be used. In this case, they are associated with a diffuser and/or optics for widening the beam to cover the whole of the touch-sensitive area.

Each imager includes focusing optics and an optical sensor. Each imager is in fact a micro-camera. The optical sensor is composed of photosensitive pixels, and may be of the area or linear type. It forms an image of the surface of the display area in a plane parallel to the plane of the display area. If there is no pointer on the display area, the sensor detects no light and the image is therefore dark. If the pointer is illuminated, it reflects and diffuses the light, which creates a luminous image on the sensors of the two imagers. The signals SC1 and SC2 delivered by the sensors and represented in FIG. 4, after processing, enable determination of the photosensitive pixels Pₖ and Pⱼ associated with the pointer as may be seen in FIG. 4. Knowing the position of these pixels Pₖ and Pⱼ, it is easy to determine the angles between the planes of the sensors and the pointer. Knowing the two angles between the pointer and the two sensors enables the position (Xp, Yp) of the pointer over the display area to be determined by triangulation.

Prior calibration enables the positions and the orientations of the sensors relative to each other to be determined.

The system of the invention, in particular when it is used in an aeronautical environment, must function both under strong illumination by sunlight and, for some uses, at night.

To enable operation under solar illumination, various techniques illustrated in FIG. 5 are used. To limit the risk of saturation of the sensor of the imager C, a spectral filter F locked to the wavelength of the associated light source is added in front of the focusing optics. In this way the solar radiation is strongly attenuated without degrading the signal reflected by the pointer.

If the pointer is illuminated by sunlight, which is a major problem for existing solution based on the “optical imaging” technology, the signal captured by the detector is not disturbed. To the contrary, it is amplified and the pointer is detected better because the rest of the image is still dark.

However, if the sunlight is reflected by an object other than the pointer disposed in the field of view of the sensors, this could cause a false activation. If that object is small, of equivalent size to the pointer, the light signal received by the sensors does not mask the signal emitted by the pointer. The position of the “intrusive” object is determined as being outside the touch-sensitive area and the system therefore ignores it.

To eliminate signals sufficiently strong to mask the signal from the pointer, the touch-sensitive area is surrounded by light-absorbing edges R.A. of sufficient thickness to cover the field of view of the sensors, i.e. a few millimeters.

Finally, in some cases, judicious positioning of the imagers can eliminate a great many of the solar illumination problems. Thus when the system is disposed on an instrument panel, positioning the imagers inside the lower portion of the cockpit glare shield enables direct illumination of the sensors by the sun to be prevented.

Moreover, a judicious design of the module integrating the sensor can prevent the sun from directly illuminating the sensor. On adding a glare shield G or a sunshade to the imager as shown in FIG. 5, the sun's rays never reach the limit angle of incidence enabling direct illumination of the sensor.

At night, to ensure compatibility with the use of night vision goggles (NVG), the light sources have emission spectra situated beyond the amplification wavelength of the goggles, generally 930 nm. These sources may be laser diodes or light-emitting diodes. The sensors then have a spectral sensitivity adapted to these wavelengths.

As already stated, at least two sensors and one light source are required for operation in the so-called “mono-touch” mode detecting a single object. For operation in a mode detecting two objects, or more, known as the “dual-touch” mode, two imagers are no longer sufficient. As seen in FIG. 6, the simultaneous presence of two objects P1 and P2 at two different locations on the touch-sensitive surface will produce two images on each sensor C1 and C2. These two images have coordinates Pₖ₁ and Pₖ₂ on the first sensor and Pⱼ₁ and Pⱼ₂ on the second sensor. It is of course impossible to determine to which object these different coordinates belong. In graphical terms, as seen in FIG. 6, there may be four objects, the two real objects P1 and P2 and two phantom objects or “ghosts” G1 and G2.

To resolve the indeterminacy, it suffices to add a third imager C3 as seen in FIG. 7. The disposition of this third imager depends of course on the position of the first imagers and the field covered by this third imager. To ensure that the three imagers are always correctly illuminated it is also possible to add a second light source S2 as seen in FIG. 8.

However, starting from the third imager, adding a new imager and at least one light source may interfere with the signal received by the other imagers as seen in FIG. 8. It is essential that the various imagers are not illuminated directly by the sources of emission. There are two solutions to this problem.

The first is to apply different spectral filtering to the different sensors by judiciously choosing the wavelengths of the light sources. For example, the detection spectral band of the sensors 1 and 2 is adapted to the wavelength of the source 1 while the wavelength of the source 2 is rejected by spectral filtering, and the detection spectral band of the sensor 3 is adapted to the wavelength of the source 2 while the wavelength of the source 1 is rejected by different spectral filtering.

The second solution is to sequence in time the signals emitted by the light sources. FIG. 9 shows one possible example of this type of sequence in the case of a touch-sensitive system with two sources, three imagers and two detected objects. The total duration of a sequence is equal to T. This duration T is generally in the range a few milliseconds to a few tens of milliseconds. Each duration T comprises two half-periods. During the first half-period, the first source S1 is on and the second source S2 is off. The first sensor C1 and the second sensor C2 are activated, the third sensor C3 is off. During the second half-period, the first source S1 is off and the second source S2 is on. The first sensor C1 and the second sensor C2 are off, and the third sensor C3 is activated. Thus the first source never illuminates the third sensor and the second source never illuminates the first and second sensors. Analysis of the different signals SC1, SC2 and SC3 coming from the sensors enables the positions of the two objects to be determined. This solution also enables verification of correct operation of the various sensors and light sources by simultaneously activating all the sensors and light sources when no pointer is detected. This verifies that the sensors SC1 and SC2 “see” the source 82 and that the sensor SC3 “sees” the source S1.

Adding one or more sensors and one or more light sources enables, in addition to “multi-touch” operation, a redundancy that is beneficial in terms of meeting avionics safety constraints.

If a point source is used to illuminate the whole of the detection area, the illumination varies greatly according to the distance from the source of illumination. In theory, detection by the sensors is independent of the received light level. In practice, it may be advantageous for the light source to be uniformly distributed in a uniform beam covering the whole of the width of the area. To this end a light guide type of shaping optics is used to enable more uniform illumination of the designator whatever its position on the surface of the detection area.

FIG. 10 shows a first embodiment of this uniform distribution source. The source includes Fresnel reflector collimation optics. These optics are generally a portion of a parabola that may be used either in total internal reflection or in direct reflection in air. The collimated light is then diffused uniformly by a light guide GL. The sources S1 may be multiplied to cover the complete width of the detection area.

FIG. 11 shows a second embodiment of this uniform distribution source. In this case, the light guide GL includes regularly spaced diffusing patterns. These patterns are generally microprisms μP. The guide may have on its edge a film with prisms enabling improved directivity. The light is then diffused slightly but the illumination of the designator remains more uniform than with a single source.

It is equally possible to use a plurality of identical sources situated on the same side of an area to render the illumination uniform.

The optical touch-sensitive system of the invention applies very particularly to aeronautical applications and in particular to aircraft instrument panels. It is easy to adapt it to different cockpit configurations. FIGS. 12 and 13 show two different cockpit configurations. The first includes six display screens D disposed in a T-shape and the associated control panels. It can be seen that a touch-sensitive system configuration comprising seven sources S and nine imagers C is necessary to assure total coverage of the instrument panel, the latter being composed of two different planes. The second configuration includes four display screens disposed in a T-shape and the associated control panels. It can be seen that a touch-sensitive system configuration comprising six sources S and eight imagers C is necessary to assure total coverage of the instrument panel, the latter being composed of two different planes. Whatever the cockpit configuration, it suffices to place the sensors and the light sources in sufficient numbers and at strategic locations to render the whole of the instrument panel touch-sensitive, screens and buttons included.

To summarize, the optical touch-sensitive systems of the invention have the following advantages:
retaining without disturbance the optical performance of the display screens:
operation under strong illumination;
high capacity for adaptation and evolution as a function of the installations to be covered;
detection over a very large area, not necessarily homogeneous and rectangular:
high redundancy for optimum reliability and safety;
use in “dual-touch” or higher mode by adding modules without creating phantom images;
compatibility with the use of night vision goggles (sensors and light sources at wavelengths greater than 930 nm);
use of low-cost components such as linear or area sensors, laser diodes or LEDs;
a high level of system modularity, the emission sources and the imagers being separate;
fluid interaction with the pointer because the system does not necessitate application of any force;
resolution and accuracy much improved over alternative prior art solutions.

1. An optical touch-sensitive system mounted above an area of a display surface, said system comprising:
a first imager and a second imager, the optical fields of which cover at least said area,
wherein the optical touch-sensitive system comprises a first light source and a second light source, each light source arranged to produce above said area of the display surface a “luminous layer” covering at least said area, the emission spectrum of the first light source being separated of the emission spectrum of the second light source or the operating time of the first light source being separated of the operating time of the second light source, each source being separate from the first and second imagers, when a first object is situated above said area, first and second luminous images of said object given by the first light source or the second light source are captured by the first imager and the second imager, the system including analysis means enabling by triangulation of the known positions of the first and second luminous images, determination of the position of this first object above said area of the display surface.

2. The optical touch-sensitive system as claimed in claim 1, wherein it includes a third imager so that, when first and second objects are situated above the area of the display surface, first, second and third luminous images of the first object are captured by the first, second and third imagers, fourth, fifth and sixth luminous images of the second object are captured by the first, second and third imagers, the system including analysis means enabling by triangulation of the known positions of the six luminous images, determination with certainty of the position of the first object and the second object above said area of the display surface.

3. The optical touch-sensitive system as claimed in claim 1, wherein the first and second light sources emit light periodically and never simultaneously during normal operation of the optical touch-sensitive system.

4. The optical touch-sensitive system as claimed in claim 1, wherein the first light source emits in a first spectral band, the second light source emits in a second spectral band separate from the first spectral band, the imagers comprising spectral filters enabling transmission of only one of the two spectral bands.

5. The optical touch-sensitive system as claimed in claim 1, wherein the sources emit in a spectral band situated outside the amplification spectral band of night vision goggles and in that the imagers are sensitive in said spectral band of said light sources.

6. The optical touch-sensitive system as claimed in claim 1, wherein the sources include optical means arranged such that the mean illumination above the area of the display surface and in a plane perpendicular thereto is substantially constant.

7. The optical touch-sensitive system as claimed in claim 6, wherein the optical means comprise collimation optics and a light guide.

8. The optical touch-sensitive system as claimed in claim 6, wherein the optical means comprise a light guide including regularly disposed diffusing patterns.

9. The optical touch-sensitive system as claimed in claim 1, wherein the imager includes a sunshade and in that the periphery of the display surface is surrounded by a sunlight-absorbing barrier.

10. The optical touch-sensitive system as claimed in claim 1, wherein the display surface is of substantially rectangular shape and the area covers the whole of said display surface.

11. The optical touch-sensitive system as claimed in claim 1, wherein the display surface includes a plurality of areas, the system including a plurality of light sources and imagers arranged so that the position of at least one object may be determined in each area.

12. The optical touch-sensitive system as claimed in claim 1, wherein the display surface is a display screen.

13. The optical touch-sensitive system as claimed in any one of the claim 1, wherein the display surface includes static display areas.

14. The optical touch-sensitive system as claimed in claim 1, wherein the display surface belongs to an avionic system mounted in an aircraft cockpit.

15. The optical touch-sensitive system as claimed in claim 14, wherein the display surface covers a portion of or the whole of the instrument panel.

16. The optical touch-sensitive system as claimed in claim 2, wherein the first and second light sources emit light periodically and never simultaneously during normal operation of the optical touch-sensitive system.

17. The optical touch-sensitive system as claimed in claim 2, wherein the first light source emits in a first spectral band, the second light source emits in a second spectral band separate from the first spectral band, the imagers comprising spectral filters enabling transmission of only one of the two spectral bands.
